(19) United States
(12) Patent Application Publication
(10) Pub. No.: US 2026/0069492 A1
(43) Pub. Date: Mar. 12, 2026

(54) TELESCOPING PERSONAL MASSAGER

(71) Applicant: NOWW, L.L.C., Irmo, SC (US)

(72) Inventors: James Benjamin Jackson, III, Irmo, SC (US); Konstantin Dolgan, Ruston, LA (US); Ralph Hill, Shreveport, LA (US)

(21) Appl. No.: 19/325,614

(22) Filed: Sep. 11, 2025

Related U.S. Application Data
(60) Provisional application No. 63/693,816, filed on Sep. 12, 2024.

(51) Int. Cl. A61H 19/00; A61H 23/02

(52) U.S. Cl. CPC A61H 19/50; A61H 19/32; A61H 19/34; A61H 23/02; A61H 2201/14; A61H 2201/165; A61H 2201/1685; A61H 2201/169; A61H 2201/5007

(57) ABSTRACT

A telescoping personal massager includes one or more attachment members, one or more vibration devices, and a telescoping protrusion. The vibration device(s) and telescoping protrusion are each supported relative to the attachment member(s), and the telescoping protrusion is operably coupled with the vibration device(s) at a proximal end of the telescoping protrusion.

### CROSS-REFERENCE TO RELATED APPLICATION

This application claims the benefit of priority of U.S. provisional patent application Ser. No. 63/693,816, filed Sep. 12, 2024, and entitled “TELESCOPING PERSONAL MASSAGER,” the contents of which are incorporated in full by reference herein.

### TECHNICAL FIELD

The present disclosure relates generally to a telescoping personal massager.

### BACKGROUND

Various personal massagers, personal vibrators, adult toys, and the like are currently available. These devices may have many uses from medical treatment (e.g., erectile dysfunction, use in conjunction with family planning and/or fertility treatment, etc.), to personal and individual use. Some of these devices include vibration functionality to increase stimulation and are intended for use during intercourse.

However, many such devices are “novelty use only.” Even those that are fit for human use often require constant user manipulation to maintain the vibration sensation in the desired area. Personal massager devices do exist that attempt to passively apply vibration sensation to the desired area. However, such devices are often intended to be worn by the female party and do not sufficiently maintain the vibration sensation in the desired area and in particular may not simultaneously deliver vibration to the male user in a continuous manner. Some hand-held devices exist for delivering vibration for female users, but such devices also do not deliver sufficient vibration for the male user and particularly do not deliver vibration to the male user in a continuous manner.

Other devices that are intended to be worn by the male party may be able to deliver continuous vibration to the male party, but such devices typically lose contact with or become unaligned with the female target region during the out-stroke.

As such, a need exists in the art for a personal massager that overcomes the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide a telescoping personal massager that overcomes the limitations of the known art.

Generally, embodiments of the telescoping personal massager may include one or more retention members, such as conventional ring structures, which is/are worn around the male genitalia during an intimate encounter in order to apply and maintain the provided vibration sensation where desired. Such retention member(s) and/or ring structure(s) may include or be provided with one or more associated vibration devices that provide the vibration sensation to and through the same. A telescoping protrusion may be mechanically coupled to the vibration device and extend from the periphery of the retention member(s) and/or ring structure(s)—for example, from a top portion of the ring structure(s). Thus, the vibration device also provides a vibrating sensation to and through the telescoping protrusion. The telescoping protrusion is designed to make and maintain substantially continuous contact with the female genitalia during the intimate encounter, as a non-limiting example. Accordingly, the telescoping protrusion may be sprung or biased away from the top portion of the retention member(s) and/or ring structure(s), such that it is compressible but biased into an extended configuration.

The vibration device(s) may provide the vibrating sensation to and through the end (distal end) of the telescoping protrusion opposite the retention member(s) and/or ring structure(s), as well as to and through any attachment coupled to the end of the telescoping protrusion. In some embodiments, an alternative or additional vibration device may be positioned at or proximate to the distal end of the telescoping protrusion to provide substantially continuous vibration sensation at such distal end, to and through any attachment coupled to the distal end of the telescoping protrusion, to and through a base or proximal end of the telescoping protrusion (e.g., the end coupled to the retention member(s)), and/or to or through the retention member(s) and/or ring structure(s) coupled to the proximal end of the telescoping protrusion. All components of the telescoping personal massager may be disposed within a hygienic cover and/or hygienically coated, as is done for similar personal massagers. The vibration device may be battery operated, for example.

In several embodiments, the device may be configured to passively maintain the substantially continuous vibratory contact at a second user (e.g., female target) site during reciprocating motion, while simultaneously providing vibratory stimulation to the male user. Thus, embodiments of the disclosed telescoping personal massager are an improvement over prior, penis-mounted products, which may deliver continuous vibration to a male user, but such devices typically lose contact with the female/target region during the out-stroke, resulting in intermittent stimulation provided to the second/female party. Furthermore, embodiments of the disclosed telescoping personal massager are an improvement over prior female-attached products, which may deliver continuous vibration to a female user, but such devices typically do not simultaneously deliver vibration to the male user in a continuous manner.

To achieve the foregoing and other objects and advantages, in one aspect, the present subject matter is directed to a telescoping personal massager including one or more ring structures, one or more vibration devices, and a telescoping protrusion. The vibration device(s) and telescoping protrusion are each supported relative to the ring structure(s), and the telescoping protrusion is operably coupled with the vibration device(s) at a proximal end of the telescoping protrusion.

In an additional or alternative aspects, the present subject matter is directed to a telescoping personal massager including one or more retention members, one or more vibration devices, a telescoping protrusion, and one or more operable connections. The retention member(s) is configured to be worn on a body part of a male user or attached to a garment of a first user. The vibration device(s) is supported relative to the retention member(s). The telescoping protrusion is supported relative to the retention member(s) and operably coupled with the vibration device(s) positioned at a proximal end of the telescoping protrusion. The telescoping protrusion is configured to passively maintain contact between a distal end of the telescoping protrusion and an anatomy of a second user during use. The operable connection(s) couples the retention member(s), the vibration device(s), and the telescoping protrusion together. The operable connection includes a control unit configured to provide operation control of the vibrational device(s).

In at least one embodiment, the vibration device(s) may be coupled between the retention member(s) and the telescoping protrusion. Additionally or alternatively, the vibration device(s) may be disposed at a periphery of one or more ring structures of the retention member(s). Furthermore or in different embodiments, the telescoping protrusion may be operably coupled directly to the vibration device(s). Additionally or alternatively, the telescoping protrusion may include an internal waveguide configured to operably couple to the vibration device(s) and to communicate vibrations from the vibration device(s) to the distal end of the telescoping protrusion. In additional or alternative embodiments, the retention member(s) may include an internal waveguide member configured to operably couple with the vibration device(s) and to communicate vibrations from the vibration device(s) throughout the retention member(s).

Additionally or alternatively, the vibration device(s) may include a vibration device coupled to the distal end of the telescoping protrusion opposite a proximal end coupled to the retention member(s). In some such embodiments or different embodiments, the vibration device(s) may include a first vibrational device coupled between the retention member(s) and the telescoping protrusion and a second vibrational device coupled at the distal end of the telescoping protrusion opposite the proximal end coupled to the retention member(s).

In further or alternative embodiments, the telescoping personal massager may include an operable junction selectively coupled between the vibration device(s) and the telescoping protrusion. Furthermore or alternatively, the operable junction may be operably coupled to the vibration device(s) and configured to selectively couple to the telescoping protrusion. Additionally or alternatively, the telescoping personal massager may include an electronics module selectively receivable at a proximal end of the telescoping protrusion and configured to control operation of the vibration device(s). The electronics module may house the vibration device(s) such that receipt of the electronics module at the proximal end of the telescoping protrusion operably couples the vibration device(s) to the ring structure(s) and the telescoping protrusion.

Additionally or alternatively, the telescoping protrusion may define a distal cross-sectional dimension less than a proximal cross-sectional dimension. In some such embodiments, the telescoping protrusion may taper from a position of the proximal cross-sectional dimension to a position of the distal cross-sectional dimension. Additionally or alternatively, a length of the telescoping protrusion may be biased to a fully extended length and compressible along the length in use. Furthermore or alternatively, the telescoping protrusion may include a two or more telescoping nested tube structures and an internal spring configured to bias a length of the telescoping protrusion to a fully extended length. Additionally or alternatively, the telescoping protrusion may include a proximal end fixed relative to the at least one retention member and opposite the distal end and a compressible element operably coupled between the proximal end and the distal end. Additionally or alternatively, the telescoping protrusion may further include one or more elastomeric bellows or elastomeric springs configured to bias a length of the telescoping protrusion to a fully extended length. In some such embodiments or different embodiments, the distal end of the telescoping protrusion may be configured to selectively retain a distal attachment. In further or different embodiments, the telescoping protrusion may be configured to communicate vibration generated by vibration device(s) such that simultaneous vibration is provided at each of the distal attachment and the retention member(s) during use of the telescoping personal massager.

In at least one embodiment, the retention member(s) may include a first ring structure and a second ring structure. In some such embodiments, each of the vibration device(s) and the telescoping protrusion may be coupled between the first ring structure and the second ring structure. In some such embodiments or different embodiments, the first ring structure may be defined along a first plane, and the second ring structure may be defined along a second plane pivotably coupled to the first ring structure such that an angle between the first plane and the second plane is selectively adjustable. Additionally or alternatively, the angle defined between the first plane and the second plane may be between 0 degrees and 45 degrees, such as a fixed angle between 0 degrees and 45 degrees.

In additional or alternative embodiments, the telescoping personal massager may include a hygienic cover enclosing one or more of the retention member(s), the vibration device(s), or the telescoping protrusion. Additionally or alternatively, the hygienic cover may include a zoned durometer, a gradient durometer, or both configured to alter a stiffness of the telescoping protrusion. Furthermore or alternatively, the telescoping personal massager may include a hygienic cover enclosing the telescoping protrusion and defining a plurality of torus sections. In some such embodiments, each torus section may define a distinct maximum radial dimension, and the torus sections may be arranged sequentially with a proximal torus section defining a largest distinct maximum radial dimension and enclosing a proximal end of the telescoping protrusion. In some such embodiments or alternative embodiments, the torus sections may decrease in the distinct maximum radial dimensions sequentially from the proximal torus section to a distal torus section defining the smallest distinct maximum radial dimension and enclosing the distal end of the telescoping protrusion.

In an additional or alternative aspect, the present subject matter is directed to telescoping personal massager including one or more retention members, a telescoping protrusion, a first vibration device, a distal attachment, a proximal operable connection, and one or more electrical conduits. The retention member(s) is configured to be worn on a body part of a male user or attached to a garment of a first user. The telescoping protrusion is supported relative to the retention member(s) at a proximal end of the telescoping protrusion. The first vibration device is coupled between the retention member(s) and the telescoping protrusion. The distal attachment is configured to selectively couple to a distal end of the telescoping protrusion and includes a second vibration device. The proximal operable connection couples the first vibration device to the telescoping protrusion and includes a control unit configured to control operation of the first vibration device and the second vibration device. The electrical conduit(s) is selectively couplable between the control unit and the second vibration device and is receivable within the telescoping protrusion. Furthermore, the telescoping protrusion is configured to passively maintain contact between the distal attachment and an anatomy of a second user during use of the telescoping personal massager.

In at least one embodiment, the telescoping personal massager may include a distal operable connection configured to allow the selective coupling of the distal attachment to the distal end of the telescoping protrusion. In some such embodiments, the distal operable connection may include a quick-disconnect electrical interface.

In an additional or alternative aspect, the present subject matter is directed to telescoping personal massager including one or more retention members, a telescoping protrusion, a distal attachment, a proximal operable connection, a distal operable connection, and one or more electrical conduits. The retention member(s) is configured to be worn on a body part of a male user or attached to a garment of a first user. The telescoping protrusion is supported relative to the retention member(s) at a proximal end of the telescoping protrusion. The distal attachment is configured to selectively couple to a distal end of the telescoping protrusion and includes a vibration device. The proximal operable connection couples the retention member(s) to the telescoping protrusion and includes a control unit configured to control operation of the vibration device. The distal operable connection is configured to allow the selective coupling of the distal attachment to the distal end of the telescoping protrusion. The electrical conduit(s) is selectively couplable between the control unit and the second vibration device and is receivable within the telescoping protrusion. Furthermore, the telescoping protrusion is configured to communicate vibration generated by the vibration device such that simultaneous vibration is provided at each of the distal attachment and the retention member(s) during use of the telescoping personal massager.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the accompanying drawings, in which:

FIG. 1A illustrates a schematic diagram of an exemplary embodiment of a telescoping personal massager, in accordance with aspects of the present subject matter;

FIG. 1B illustrates a schematic diagram of an exemplary embodiment of a telescoping personal massager including two retention members, in accordance with aspects of the present subject matter;

FIG. 1C illustrates a schematic diagram of an exemplary embodiment of a telescoping personal massager including two retention members and a distal vibration device, in accordance with aspects of the present subject matter;

FIG. 1D illustrates a schematic diagram of an exemplary embodiment of a telescoping personal massager including two retention members, a proximal vibration device, and a distal vibration device, in accordance with aspects of the present subject matter;

FIG. 1E illustrates a schematic diagram of an exemplary embodiment of a telescoping personal massager including two retention members, a proximal vibration device, a distal vibration device, and a distinct distal attachment, in accordance with aspects of the present subject matter;

FIG. 1F illustrates a schematic diagram of an exemplary embodiment of a telescoping personal massager including two retention members, a proximal vibration device, and a distal attachment including an integrated distal vibration device, in accordance with aspects of the present subject matter;

FIG. 2 illustrates a perspective view of an exemplary embodiment of a telescoping personal massager, in accordance with aspects of the present subject matter;

FIG. 3 illustrates a partially exploded perspective view of an exemplary embodiment of a telescoping personal massager, in accordance with aspects of the present subject matter;

FIG. 4 illustrates a side view of an exemplary embodiment of a telescoping personal massager, in accordance with aspects of the present subject matter;

FIG. 5 illustrates a front view of an exemplary embodiment of a telescoping personal massager, in accordance with aspects of the present subject matter;

FIG. 6 illustrates an exploded perspective view of an exemplary embodiment of an electronics module suitable for use with a telescoping personal massager, in accordance with aspects of the present subject matter;

FIG. 7A illustrates a partially exploded perspective view of an exemplary embodiment of a telescoping personal massager in a fully extended configuration and with a distal attachment removed, in accordance with aspects of the present subject matter;

FIG. 7B illustrates a partially exploded perspective view of an exemplary embodiment of a telescoping personal massager in a fully compressed configuration and with a distal attachment removed, in accordance with aspects of the present subject matter;

FIG. 8A illustrates a partially exploded perspective view of an exemplary embodiment of a telescoping personal massager in a fully extended configuration with optional distal attachments, in accordance with aspects of the present subject matter;

FIG. 8B illustrates a partially exploded perspective view of an exemplary embodiment of a telescoping personal massager in a fully compressed configuration with optional distal attachments, in accordance with aspects of the present subject matter; and

FIG. 9 illustrates side cross-sectional views of an exemplary embodiment of a telescoping personal massager in a fully compressed configuration and in a fully extended configuration, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Generally, embodiments of the telescoping personal massager may include one or more retention members, such as conventional ring structures, which may be worn around the male genitalia during an intimate encounter in order to apply and maintain the provided vibration sensation where desired. Alternatively, such retention member may selectively couple the telescoping personal massager to a garment of a first user. Such retention member(s) and/or ring structure(s) may include or be provided with one or more associated vibration devices that provide the vibration sensation to and through the same. A telescoping protrusion may be mechanically coupled to the vibration device and extend from the periphery of the retention member(s) and/or ring structure(s)—for example, from a top portion of the ring structure(s). Thus, the vibration device also provides a vibrating sensation to and through the telescoping protrusion. The telescoping protrusion is designed to make and maintain contact with the female genitalia during the intimate encounter, as a non-limiting example. Accordingly, the telescoping protrusion may be sprung or biased away from the top portion of the retention member(s) and/or ring structure(s), such that it is compressible but biased into an extended configuration.

The vibration device(s) may provide the vibrating sensation to and through the end (distal end) of the telescoping protrusion opposite the retention member(s) and/or ring structure(s), as well as to and through any attachment coupled to the end of the telescoping protrusion. In some embodiments, an alternative or additional vibration device may be positioned at or proximate to the distal end of the telescoping protrusion to provide vibration sensation at such distal end, to and through any attachment coupled to the distal end of the telescoping protrusion, to and through a base or proximal end of the telescoping protrusion (e.g., the end coupled to the retention member(s)), and/or to or through the retention member(s) and/or ring structure(s) coupled to the proximal end of the telescoping protrusion. All components of the telescoping personal massager may be disposed within a hygienic cover and/or hygienically coated, as is done for similar personal massagers. The vibration device may be battery operated, for example.

In several embodiments, the device may be configured to passively maintain substantially continuous vibratory contact at a second user (e.g., female target) site during reciprocating motion, while simultaneously providing vibratory stimulation to the male user. Thus, embodiments of the disclosed telescoping personal massager are an improvement over prior, penis-mounted products, which may deliver continuous vibration to a male user, but such devices typically lose contact with the female/target region during the out-stroke, resulting in intermittent stimulation provided to the second/female party. Furthermore, embodiments of the disclosed telescoping personal massager are an improvement over prior female-attached products, which may deliver continuous vibration to a female user, but such devices typically do not simultaneously deliver vibration to the male user in a continuous manner. The application of substantially continuous vibration or substantially continuous contact, as used herein may refer to contact which is continuous over a threshold percentage of time in a given interval. For instance, substantially continuous vibration or substantially continuous contact may mean vibration applied or contact maintained for at least 80 to 95 percent of a reciprocation cycle over a representative stroke and frequency, with a nominal preload range, as a non-limiting example.

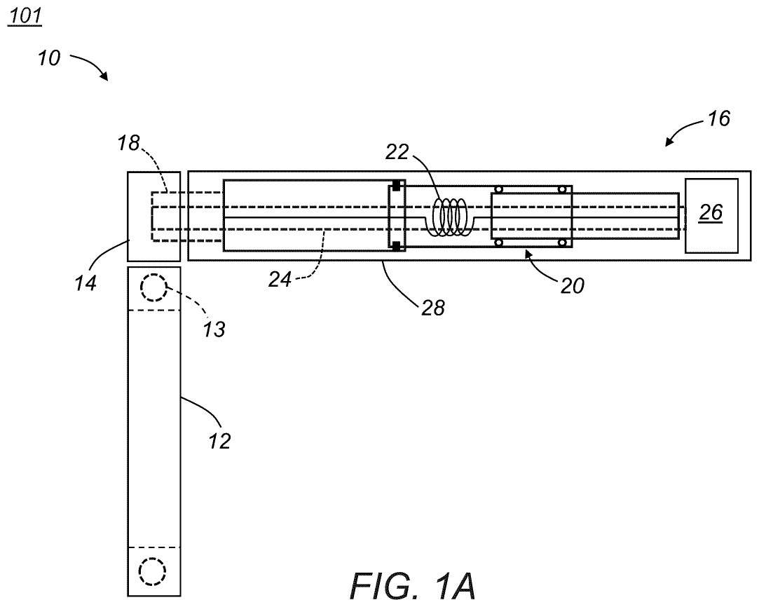

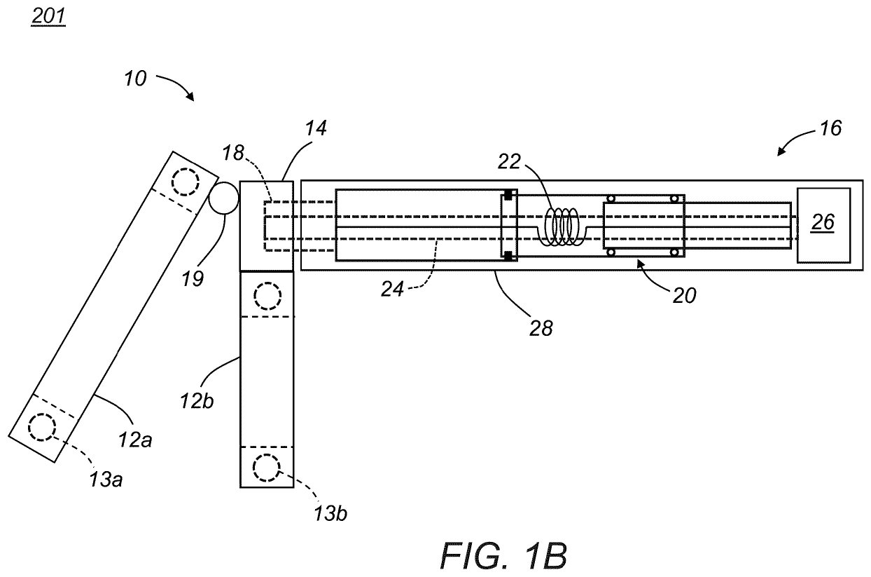

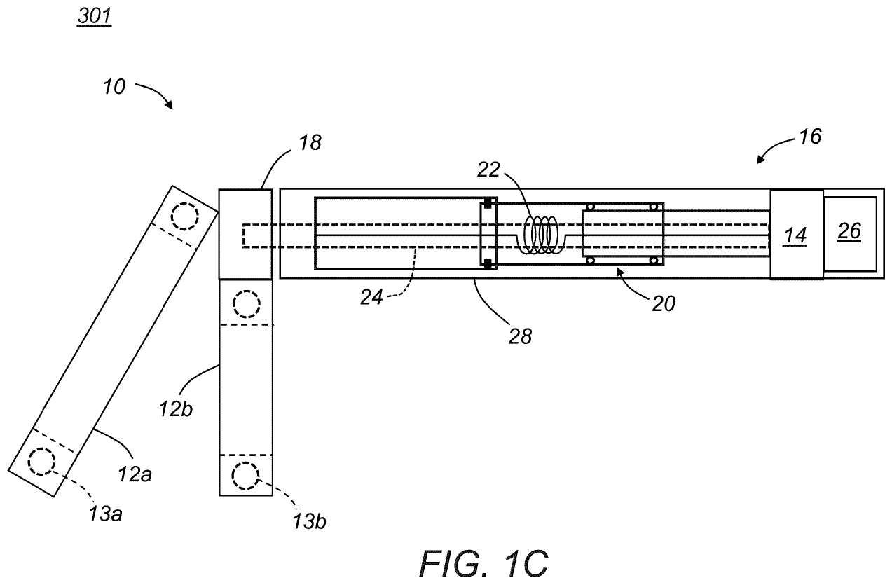

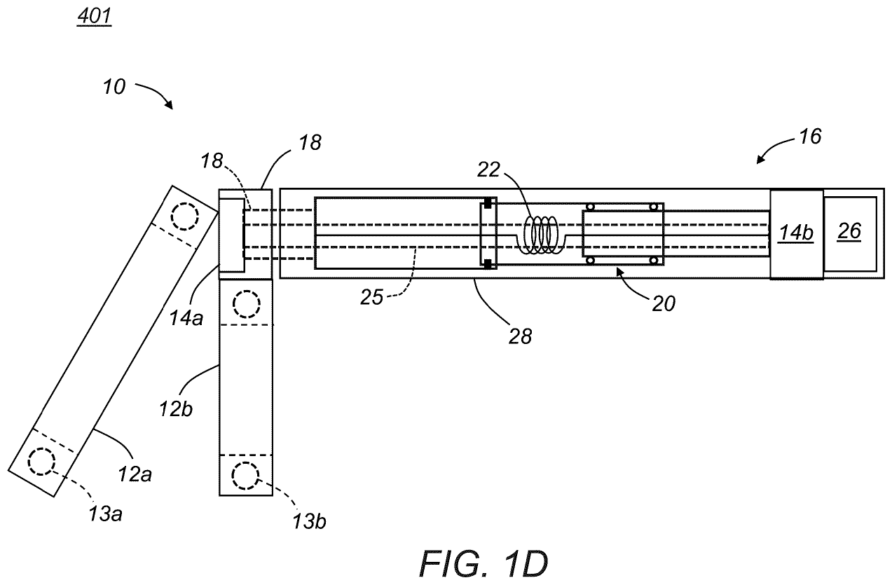

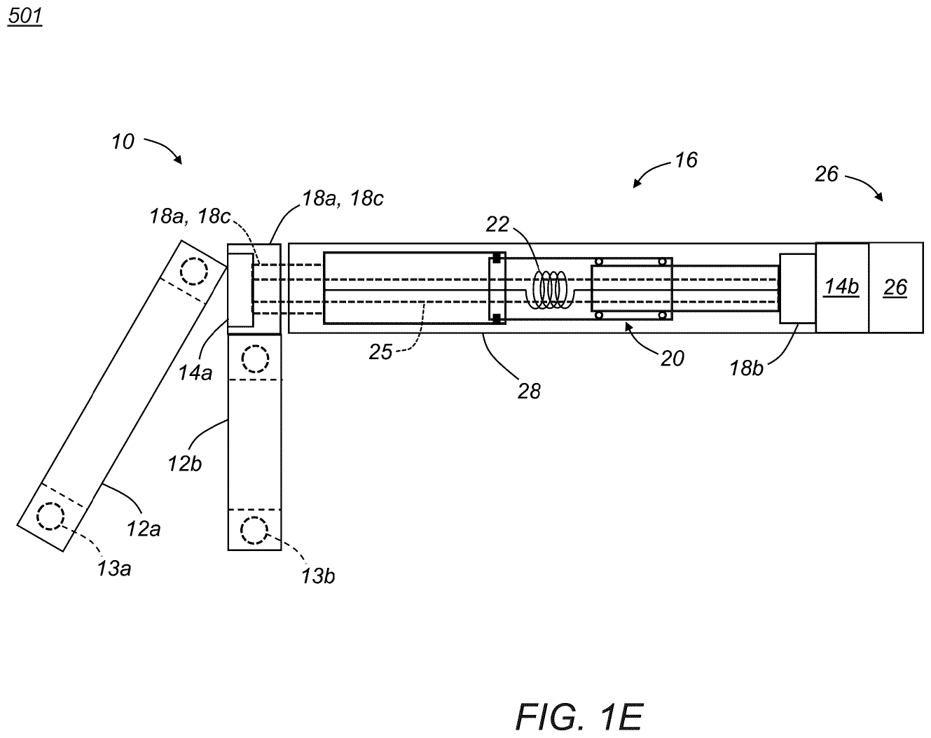

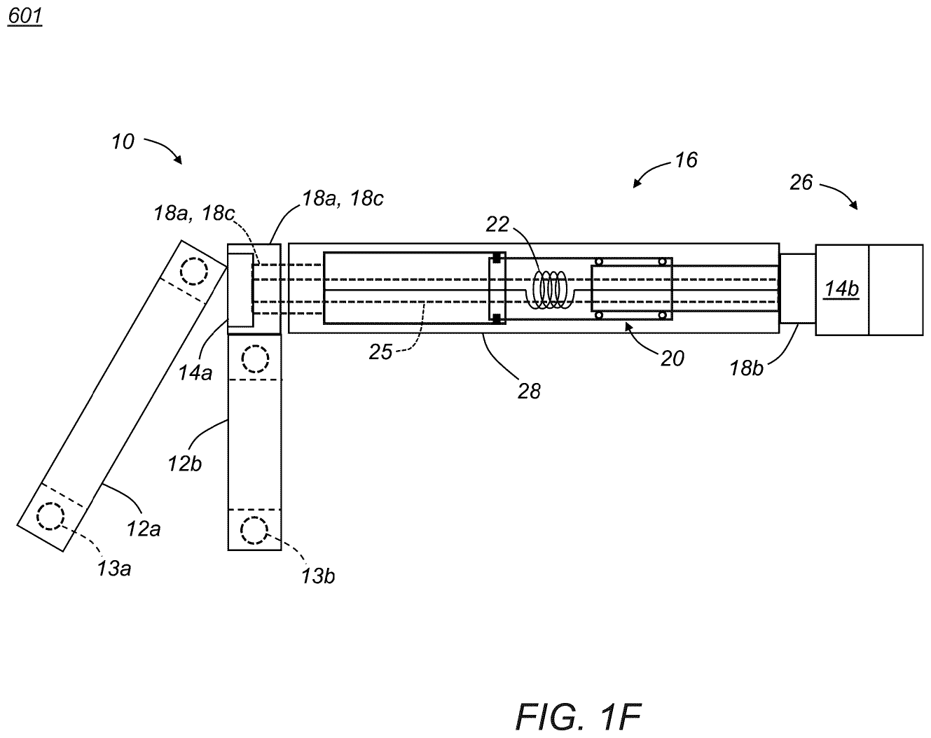

Referring now generally to the drawings, FIGS. 1A-1F illustrate schematic diagrams of exemplary embodiments of a telescoping personal massager (TPM), in accordance with aspects of the present subject matter. The TPM 10 may include one or more retention members, garment interfaces, or conventional ring structures (referred collectively as ring structures 12 herein), e.g., a single ring structure 12 shown in FIG. 1A and dual/multiple ring structures 12a and 12b illustrated in FIGS. 1B-1F. The ring structure(s) 12, 12a, 12b may be worn around the male genitalia during an intimate encounter.

In the depicted embodiments with double ring structures 12a, 12b, such ring structures 12a, 12b may be angled with respect to one another. For instance, the first ring structure 12a may be defined along a first plane (e.g., normal to a centerline thereof), and the second ring structure 12b may be defined along a second plane angled relative to the first plane. While such planes may be flat in several embodiments, it should be appreciated that such planes may themselves be curved planes, and/or the herein disclosure is equally applicable to ring structures with geometry that cannot be defined within a single, flat plane. Additionally or alternatively, an angle defined between the first ring structure 12a (e.g., the first plane) and the second ring structure 12b (e.g., the second plane) may be between 0 degrees and 45 degrees, such as between 20 degrees and 40 degrees, such as between 25 degrees and 35 degrees, such as approximately 30 degrees, such as 30 degrees.

In an alternative configuration and as illustrated particularly in FIG. 1B, some embodiments of the TPM 10 may include an angle adjustment mechanism 19 coupled between the first ring structure 12a and the second ring structure 12b and configured to allow for alteration of the angle between the respective first plane and second plane of the ring structures 12a, 12b. For example, adjustment mechanism 19 may generally include a pivotable connection, retained rod, axle, or the like allowing for manipulation of the angle defined between the ring structures 12a, 12b or the planes defined by such ring structures 12a, 12b. Some configurations of the angle adjustment mechanism 19 may include a locking mechanism allowing such angle between the ring structures 12a, 12b to be selectively fixed.

In some embodiments and as shown, the ring structure(s) 12 may include or be provided with one or more vibration devices 14 configured to provide a vibrating sensation to and through the ring structure(s) 12. Generally, the vibrational device(s) 14 may be supported relative to the ring structures 12, 12a, and/or 12b, and optionally through telescoping protrusion 16 (e.g., FIG. 1C-IF). In some embodiments and as shown particularly in FIGS. 1A-1B, one or more of the vibration devices 14 may be coupled, physically coupled, or operably coupled between the ring structure(s) 12, 12a, and/or 12b and the telescoping protrusion 16. Furthermore and in some embodiments, one or more of the vibration devices 14 and/or the telescoping protrusion 16 may be coupled, physically coupled, or operably coupled between any of the ring structure(s) 12, 12a, and/or 12 (e.g., FIG. 1B).

The vibration device(s) 14 may be a battery-operated electromechanical device that is adapted to impart vibration waves to the ring structure(s) 12, such as to one or more internal ring members (e.g., ring waveguide 13, 13a, and/or 13b) and/or the external surface(s) of the ring structure(s) 12. Generally, a waveguide, ring waveguide, protrusion waveguide, internal waveguide, and the like, as used herein, refer to members or structures (linear, circular, or another suitable shape) with reduced attenuation of vibrational signals compared to surrounding material. Waveguides and particularly vibrational and acoustic waveguides are well known to those of ordinary skill in the art and are not described in greater detail herein.

In some embodiments and as illustrated particularly in FIGS. 1A and 1B, vibration device(s) 14 may be disposed anywhere around the periphery of the ring structure(s) 12—for example, from the top portion of the ring structure 12, the ring structure 12a, the ring structure 12b, or a combination thereof. The vibration device(s) 14 may incorporate any suitable actuation mechanism or combination of such mechanisms.

A telescoping protrusion 16 may also be operably and/or mechanically coupled to the vibration device(s) 14 and extend from the periphery of the ring structure(s) 12, 12a, 12b. For example, the telescoping protrusion 16 may extend from a top portion of one or more of, each of, or a combination of the ring structure(s) 12, 12a, 12b. The telescoping protrusion 16 is generally configured to make and maintain contact, such as substantially continuous contact, with the target area (e.g., female genitalia) during the intimate encounter, for example. Accordingly, the telescoping protrusion 16 may be sprung or biased away from the top portion of the ring structure(s) 12, 12a, 12b, such that it is compressible but biased into an extended configuration (e.g., a fully extended length).

In some configurations and as shown, the telescoping protrusion 16 may include a plurality of telescoping nested tube structures 20 encompassing an internal spring 22. Generally, the telescoping protrusion 16 and/or an associated hygienic cover, portion thereof, subcomponents thereof, or the like (e.g., hygienic cover 28 discussed in more detail below) may taper along the length of the telescoping protrusion 16 from the proximal end to the distal end. For example, the telescoping protrusion 16 may define a distal cross-sectional dimension less than a proximal cross-sectional dimension, and the telescoping protrusion 16 may taper from a position of the proximal cross-sectional dimension to a position of the distal cross-sectional dimension.

However, it should be appreciated that alternative configurations are possible, provided that the telescoping protrusion 16 is compressible but biased into an extended configuration. Generally, the telescoping protrusion 16 may include a proximal end fixed relative to the ring structure(s) 12, a distal end, and a compressible element operably coupled between the proximal end and the distal end. For example, the telescoping protrusion 16 may include a simple spring mechanism including two ends separated by a spring or a compressible body of resilient material. For example and in an alternative configuration, the hygienic cover 28 or portion thereof may act to bias the telescoping protrusion 16 to the fully extended position. In various embodiments, the hygienic cover 16 may be configured to elastically deform along the compressible length of the telescoping protrusion 16 and thus assist with or fully bias the telescoping protrusion 16 to the fully extended position. In additional or alternative embodiments, the telescoping protrusion 16 may include one or more elastomeric corrugations, elastomeric bellows, compression or torsion springs, living hinges or flexures, contoured pads, and/or other geometry suitable to maintain the distal end of the telescoping protrusion engaged (e.g., substantially continuously) with the target area, female anatomy, or the like in use. Typically, the telescoping protrusion 16 has a substantially cylindrical shape, although other shapes may be used as desired.

Furthermore, the elastic or elastomeric portions of the ring structure(s) 12, 12a, 12b and/or telescoping protrusion may include one or more durometers, shore durometers, Shore A durometers, or the like configured to permit adjustability of the stroke range and/or angle range of the TPM 10. For instance, one or more zoned or gradient durometers may be included and configured to allow tuning of the stiffness associated with the TPM 10, the ring structure(s) (e.g., 12, 12a, and/or 12b), and/or the telescoping protrusion 16. It should be appreciated that such adjustment of the stiffness may include an adjustment of the provided force biasing the telescoping protrusion 16 to the fully extended position or additionally or alternatively cause the telescoping protrusion 16 (e.g., the distal end thereof) to be biased in an upward direction as well as adjustment of this upward biasing force.

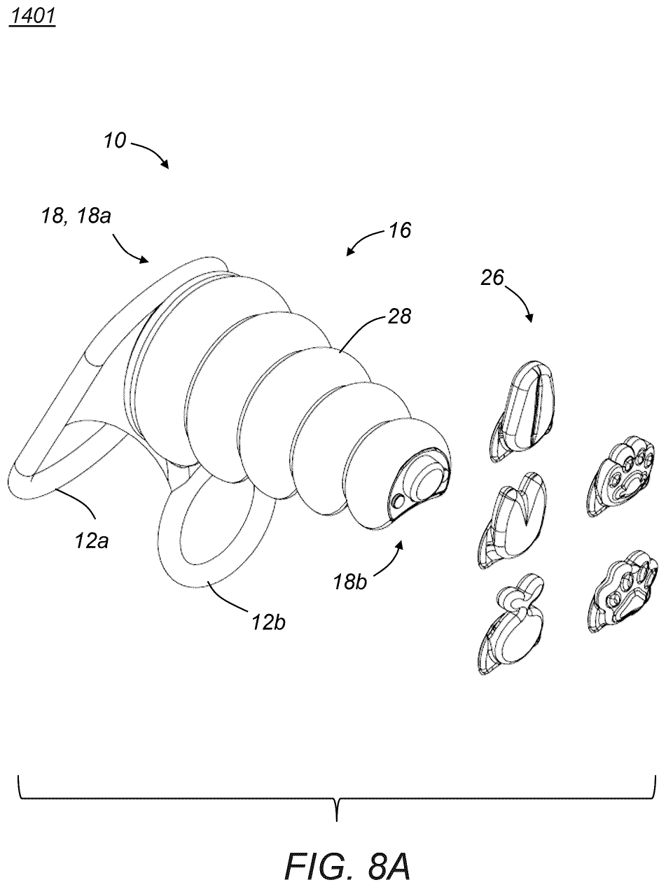

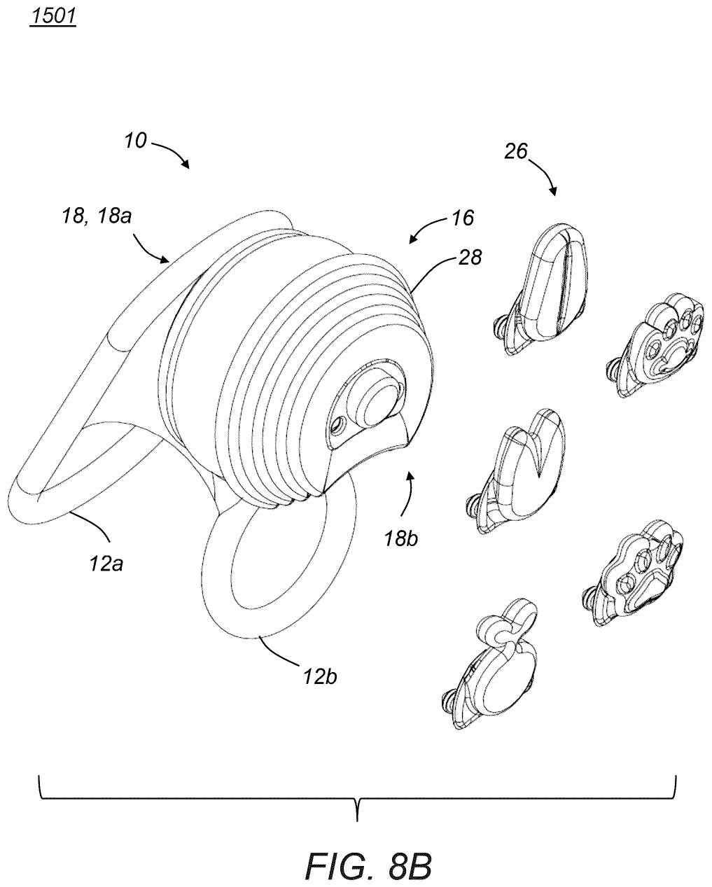

The telescoping protrusion 16 may include an internal waveguide configured to operably couple to the vibration device(s) 14 and to communicate vibrations from the vibration device(s) 14 to a distal end of the telescoping protrusion 16. For example, the vibration device 14 (e.g., proximal vibration device 14) may provide the vibrating sensation to and through the end of the telescoping protrusion 16 opposite the ring structure(s) 12, e.g., through an internal member (protrusion waveguide 24) and/or through the structure of the telescoping protrusion 16 itself, as well as to and through any attachment 26 coupled to the end of the telescoping protrusion 16, either permanently or removably. Thus, it should also be appreciated that embodiments of the TPM 10 may include a telescoping protrusion 16 configured to selectively retain a distal attachment 26 at the distal end of the telescoping protrusion 16. Generally, numerous distal attachments 26 may be provided and selectively utilized with the TPM 10 based on the personal preferences of the users, as discussed more particularly below with respect to FIG. 8.

In some configurations, all components of the TPM 10 may be disposed within the hygienic cover 28 and/or hygienically coated, as is done for similar personal massagers, and any desired external texture may be provided. In FIGS. 1A-IF, only the portion of the hygienic cover 28 associated with the telescoping protrusion 16 is illustrated for clarity. However, the other components of the TPM 10 (e.g., 12, 12a, 12b, 14, 18) may similarly include the hygienic cover 28. For example, all components of the ring structure(s) 12, the vibration device(s) 14, the telescoping protrusion 16, and/or the distal attachment 26 may be disposed within a hypoallergenic silicone rubber cover or the like. Such hygienic cover 28 may be an integral component or include multiple subcomponents associated with one or more other components, parts, portions, or the like of the TPM 10. All dimensions may also be varied as desired, including the inside diameter of the ring structure 12 and the compressed/extended length of the telescoping protrusion 16. For example, the number of nested tube structures 20 may be increased or decreased or exchanged for other suitably configured nesting tube structures 20 with different dimensions, lengths, widths, diameters, profiles, curves along the lengths thereof, or the like. In other embodiments, nested tube structures 20 may be omitted all together.

The telescoping protrusion 16 may be permanently affixed to the vibration device(s) 14, or it may include one or more associated operable junctions 18 for removable or selectively attaching the telescoping protrusion 16 to one or more of the provided vibration devices 14. In some embodiments, the operable junction 18 may be operably coupled to the vibration device(s) 14 and selectively couplable to the telescoping protrusion 16.

For example, the operable junction 18 or a subcomponent thereof may function as a junction or primary junction coupling all of the components of the TPM 10 together, as context dictates. Additionally or alternatively, the operable junction 18 may include any user interface elements, electrical components or connections, power supplies, charging modules, control units, battery device, processors, memory devices, controllers, microcontrollers, etc. (e.g., within an electronics module 18c) configured to implement vibration of the vibrational devices 14 and/or provide multiple different vibrational modes for user preferences.

The vibration device(s) 14 may also provide a vibrating sensation to and through the telescoping protrusion 16. In configurations with a vibration device 14 positioned at or included at the distal end of the telescoping protrusion 16 (e.g., FIG. 1C), the distal vibration device 14 may be permanently affixed to the telescoping protrusion 16 while the telescoping protrusion 16 is selectively or removably attached to the ring structure(s) 12, 12a, and/or 12b through the operable junction 18. For instance, a single vibration device 14 permanently or semi-permanently coupled to a distal end of the telescoping protrusion 16 is illustrated in the exemplary embodiment of FIG. 1C.

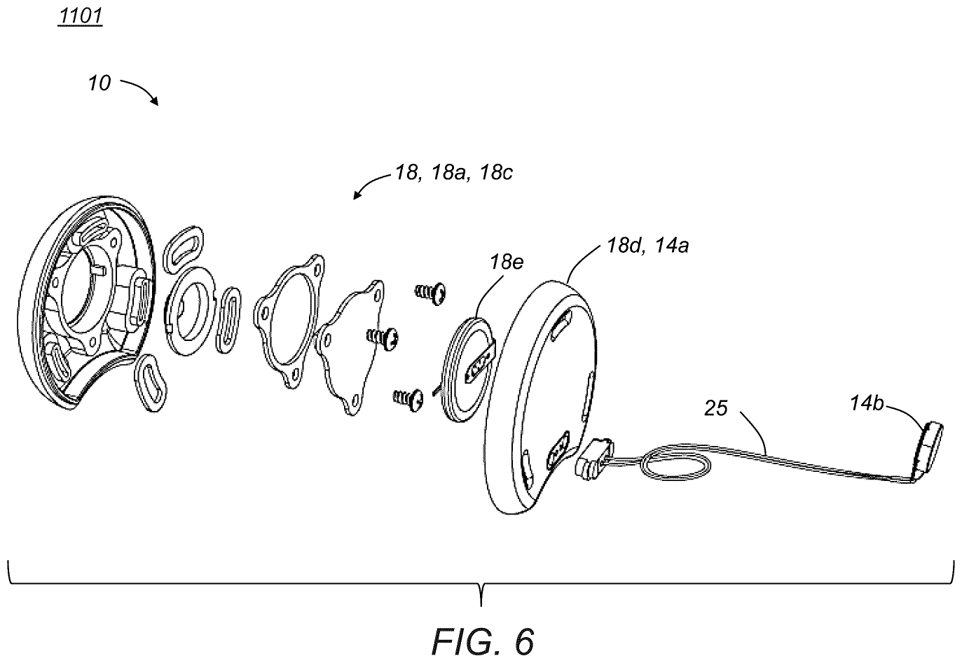

In other embodiments and as shown in FIG. 1D-1F, a proximal vibration device 14a may be selectively coupled with the telescoping protrusion 16 utilizing one or more operable junctions 18 provided near the ring structures(s) 12, 12a, and/or 12b. The telescoping protrusion 16 may also include a distal vibration device 14b permanently (e.g., FIG. 1D) or semi-permanently (e.g., FIGS. 1E-1F) coupled to a distal end of the telescoping protrusion 16. In embodiments with both the proximal and distal vibration devices 14a, 14b, the protrusion waveguide 24 may not be necessary and excluded. In such embodiments, one or more electrical conduits 25 may be provided to operably or electrically couple the operable junction 18 or a proximal operable junction 18a (e.g., an electrical module 18c and/or a control unit 18d thereof as described in more detail with respect to FIG. 6 below) in order to power and provide control of such distal vibration device 14b, e.g., various modes such as synchronous, asynchronous, and/or phase-offset modes. However, some embodiments may include both the electrical conduits 25 for providing operable control of the distal vibration device 14b in addition to the protrusion waveguide 24 (omitted from FIGS. 1D-1F for clarity) such that the vibration devices 14a, 14b are mechanically coupled and/or such that vibrations generated from such devices are transferred through the body of the telescoping protrusion 16.

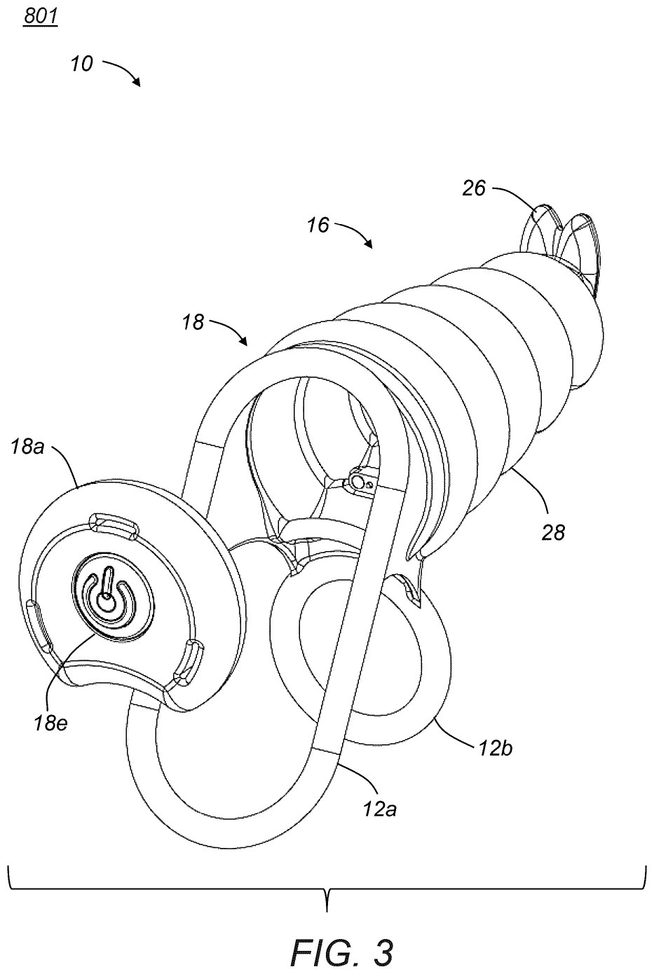

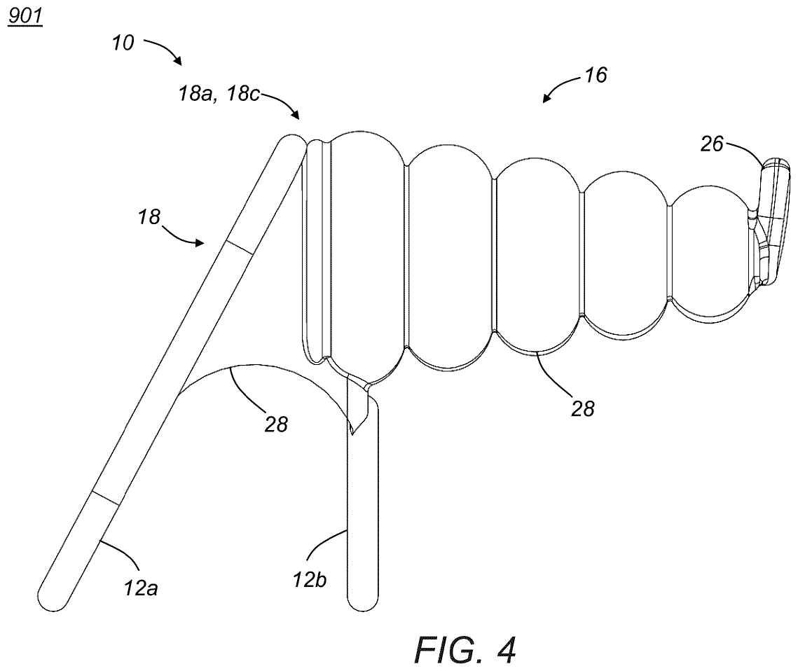

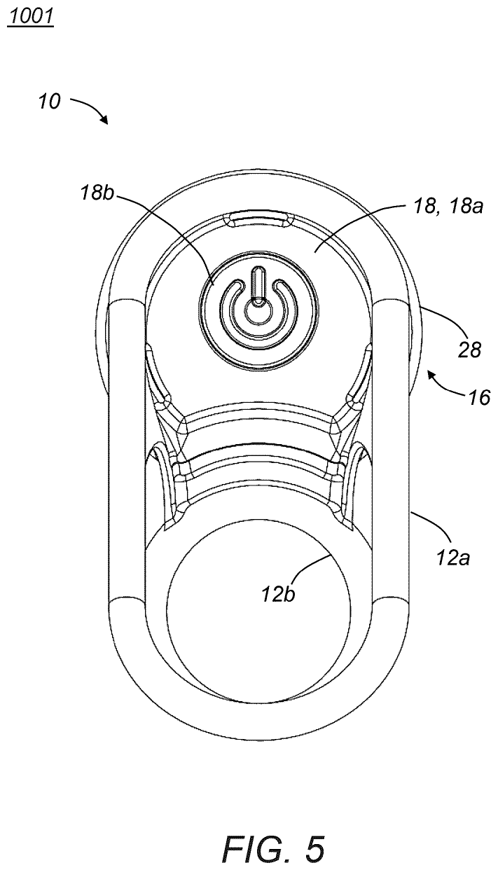

While a single, proximal operable junction 18 is illustrated in FIGS. 1A-1D, embodiments of the present disclosure may additionally or alternatively include a distal operable junction 18b for removably coupling a distal vibration device 14b to the distal end of the telescoping protrusion 16 in addition or as an alternative to such a proximal operable junction 18a (e.g., FIG. 1E). Furthermore, the proximal junction 18a may additionally or alternatively include or be configured as an electronics module 18c (described in more detail below with respect to FIG. 6), a base module, a housing module, or the like that receives other components of the TPM 10 and couples such components together, e.g., physically, operably, electrically, or the like (e.g., FIGS. 3-5 discussed in more detail below).

In other embodiments and as shown in the exemplary embodiments of FIG. 1E-IF, it should be appreciated that the telescoping protrusion 16 may be selectively coupled to each of the proximal vibration device 14a, e.g., through proximal operable junction 18a, and the distal proximal vibration device 14b, e.g., through distal operable junction 18b. Furthermore and in some embodiments, the TPM 10 and/or the proximal operable junction 18a may include the electronics module 18c to provide operable control of the proximal vibration device 14a and/or the distal vibration device 14b, such as via the electrical conduit(s) 25.

In some embodiments and as shown in FIG. 1E, the distal vibration device 14b may be permanently or semi-permanently coupled to the distal end of the telescoping protrusion 16, and the distal attachment 26 may be selectively coupled with the telescoping protrusion 16 through the distal vibration device 14b. In other embodiments and as shown in FIG. 1F, the distal attachment 26 may include an integrated distal vibration device 14b. In such embodiments, selective coupling of the distal attachment 26 with the distal operable connection 18b may also selectively couple the distal vibration device 14b with the telescoping protrusion 16 and/or the electronics module 18c positioned near the ring structure(s) 12, 12a, 12b and/or the proximal end of the telescoping protrusion 16. In such embodiments, an interface between the distal operable connection 18b and the distal attachment 26 may include one or more quick-disconnect electrical connections (e.g., pogo contacts, magnetic-assisted pogo contacts, or the like) for operably or electrically coupling the distal vibration device 14b to the electronics module 18c.

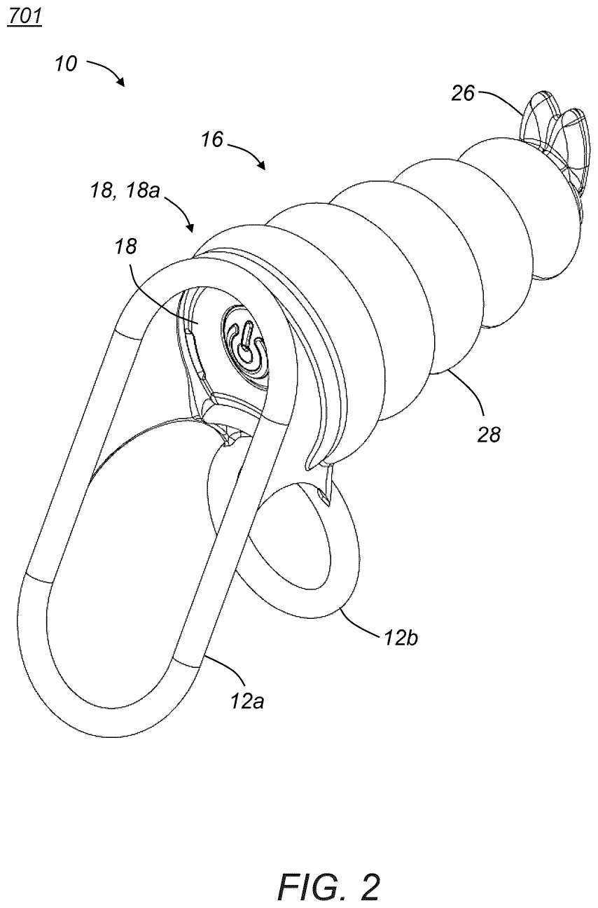

Referring now generally to FIGS. 2-5 and 7-8, multiple views of exemplary embodiments of telescoping personal massager are illustrated in accordance with aspects of the present subject matter. For instance, the embodiment of FIGS. 2-5 and 7-8 may be configured the same as or similar to the TPMs 10 described with respect to FIG. 1B (e.g., including a proximal vibration device 14), FIG. 1C (e.g., including a distal proximal vibration device 14), or FIGS. 1D-IF (e.g., including a proximal vibration device 14a and a distal vibration device 14b). However, the embodiment of FIG. 1A may be similarly configured with only one ring structure 12 rather than multiple ring structures 12a, 12b.

As shown and in some embodiments, the hygienic cover 28 may include a hygienic cover, casing, or the like for the telescoping protrusion 16. Optionally, such hygienic cover 28 for the telescoping protrusion 16 may assist an independent biasing element (e.g., spring 22) to bias the telescoping protrusion 16 to the fully extended position. Alternatively, the hygienic cover 28 may be configured to provide all of the force biasing the telescoping protrusion 16 to the fully extended position in response to compression along such length. In some embodiments, the telescoping protrusion 16 and/or the hygienic cover 28 may include or enclose elastomeric corrugations or bellows, a compression or torsion spring, a living hinge or flexure, a contoured pad, and/or other suitable geometry to keep the distal tip engaged during reciprocation. In one configuration, the hygienic cover 28 may include one or more durometers, shore durometers, A shore durometers, or the like for the elastomeric portions thereof and allowing for stroke and angle range adjustment of the telescoping protrusion 16. For example, one or more zoned durometers, gradient durometers, or the like may allow for adjustment of a compression stiffness of the telescoping protrusion 16 and/or stiffness associated with bending the telescoping protrusion 16 up or down with respect to the proximal operable connection 18a and/or the ring structure(s) 12, 12a, 12b.

It should also be appreciated that some or all of other components of the TPM 10 (e.g., 18, 12, 12a, 12b, 26) may include the hygienic cover 28, portions thereof, and/or subcomponents thereof, which may all be integrally formed in some embodiments. In other embodiments, the hygienic cover 28 of the operable junction 18 and/or proximal operable junction 18a may be a distinct subcomponents of the hygienic cover 28 relative to portions associated with the telescoping protrusion 16 and/or the ring structure(s) 12, 12a, 12b and thus permit disassembly or partial disassembly of the components of the TPM 10.

As shown particularly in FIGS. 2-4 and 7-8 and in some exemplary embodiments, the hygienic cover 28 and/or a portion thereof associated with or enclosing the telescoping protrusion 16 may define multiple torus sections, structures, or the like (e.g., the most external portions thereof and excluding the central hole of some torus structures). As described generally above, the telescoping protrusion 16 including the hygienic cover 28 thereof may taper from the proximal end(s) to the distal end(s). For instance and as depicted, such portion of the hygienic cover 28 may be defined (e.g., fully or partially) by torus sections of decreasing major dimension (e.g., diameter) arranged sequentially along the fully extended length of the telescoping protrusion 16. Additionally or alternatively, each torus section may define a distinct maximum radial dimension, and the torus sections may be arranged sequentially with a proximal torus section defining a largest distinct maximum radial dimension and enclosing a proximal end of the telescoping protrusion 16. In some such embodiments or alternative embodiments, the torus sections may decrease in the distinct maximum radial dimensions sequentially from the proximal torus section to a distal torus section defining the smallest distinct maximum radial dimension and enclosing or partially enclosing the distal end of the telescoping protrusion 16.

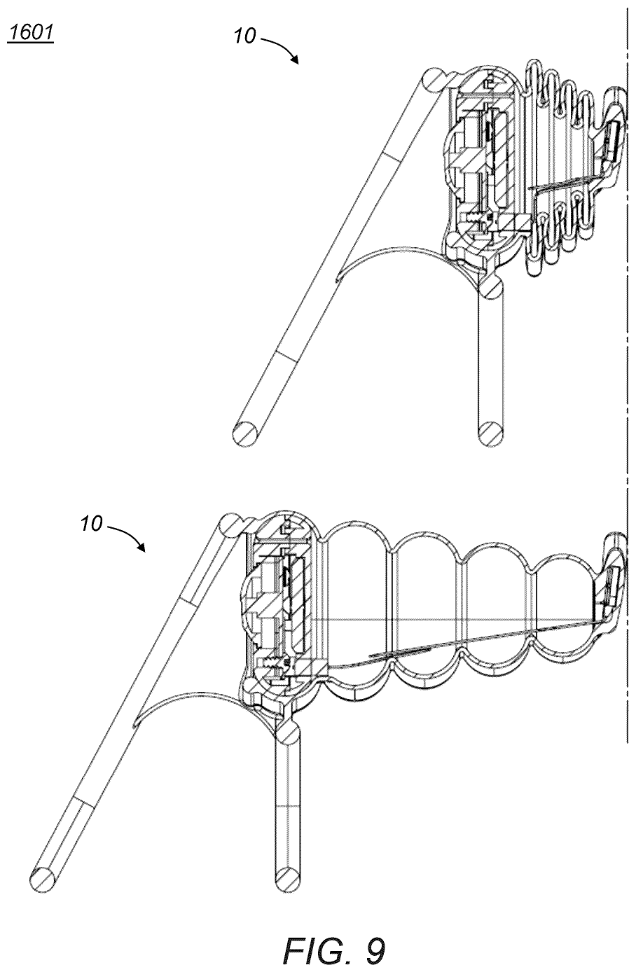

Referring now to FIG. 9, an exemplary embodiment of a personal telescoping massager is illustrated in a fully extended configuration (bottom) and in a fully compressed configuration (top), in accordance with aspects of the present subject matter. As shown, embodiments of the hygienic cover 28 defining the torus structures may allow for the telescoping protrusion 16 to be compressed with reduced binding, creases, or the like in the hygienic cover 28, which may increase the life thereof and reduce wear.

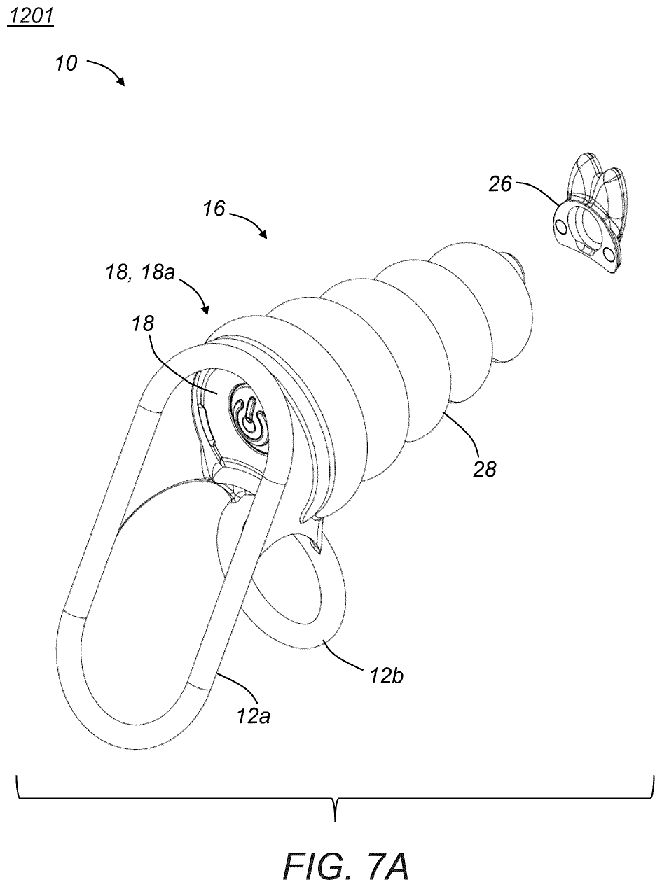

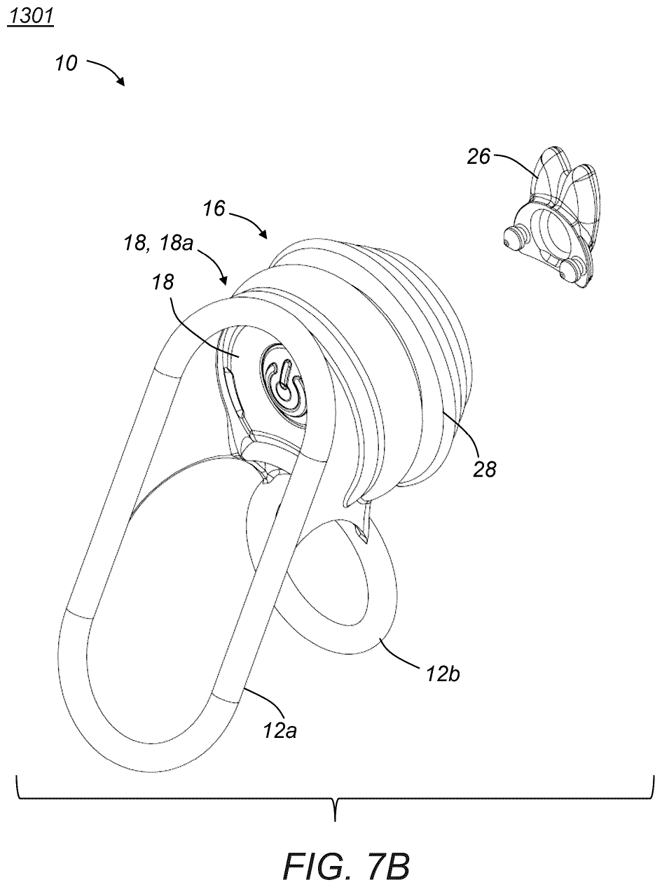

Referring now particularly to FIGS. 7-8 and in several embodiments, the distal end/tip of the telescoping protrusion 16 may be configured to selectively retain a distal attachment 26. The distal attachments 26 may generally be configured to localize the vibration provided by the TPM 10, alter an applied areas of such vibration, and/or provide different textures (divots, bumps, tactile elements, etc.) based on the personal preferences of the user.

In an exemplary embodiment, the distal attachment 26 and the distal end of the telescoping protrusion 16 may include quick-connect electrical interfaces such as pogo (e.g., FIGS. 7B and 8B) or magnetic assisted pogo connections (e.g., FIGS. 7A and 8A), which may be sealed to prevent moisture ingress within the distal attachment 26 and/or distal end of the telescoping protrusion 16. In the exemplary embodiments illustrated in FIGS. 7A and 8A, the interface between the distal attachment 26 and the distal end of the telescoping protrusion 16 may include a magnetic coupler with complimentary protrusions and extrusions. In one instance, the distal end of the telescoping protrusion 16 may include a north or south polarity magnet (e.g., end of magnet nearest the distal tip of the telescoping protrusion 16), and the distal attachment 26 may include an opposite polarity magnet (end of magnet oriented toward interface of distal attachment 26). Furthermore, the interface between the distal end of the telescoping protrusion 16 and the distal attachment 26 may include one or more complementary protrusions and cavities to fix the orientation of the distal attachment 26 relative to the telescoping protrusion 16. While an arrangement illustrating two radially exterior protrusions and a central, larger protrusion on the distal end of the telescoping protrusion 16 is illustrated, the opposite configuration, a mixed configuration, and additional and/or alternative configurations are possible. Generally, the interface of the distal attachment 26 may include complementary geometry to the interface of the distal end of the telescoping protrusion 16. In additional or alternative embodiments, the distal attachment 26 may be configured to be snap fit (e.g., FIGS. 7B and 8B), thread, or couple utilizing a bayonet with a distal end of the telescoping protrusion 16.

In several embodiments, the distal attachment 26 may define a pronged or forked shape and/or may be angled upward with respect to a longitudinal axis of the telescoping protrusion 26. For example, the distal attachment 26 may define a bunny ears shape. In additional or alternative non-limiting examples, the distal attachment 26 may define a dog paw shape, a cat paw shape, a tongue shape, or a two-drop shape. It should be appreciated that the desired distal attachment 26 may be selectively coupled to the distal end of the telescoping protrusion 16, e.g., utilizing the magnetic coupler and/or other suitable means. Furthermore, the TPM 10 and various of the distal attachments 26 may be provided in a kit and potentially with a charging device suitable to charge an associated battery. In one instance, the charging device may be a charging cradle permitting wired or wireless charging of the TPM 10, although other charging means contemplated and may be equally suitable for use with embodiments of the TPM 10 disclosed herein.

In alternative embodiments/configurations, a single distal attachment 26 may be permanently coupled to the end/tip of the telescoping protrusion 16, which may allow the distal attachment 26 to be integrally coated with the same hygienic cover 28 as the telescoping protrusion 28. However, it should be appreciated that some embodiments of the telescoping protrusion 16 may not be configured to receive any such distal attachment 26 at all. Thus and in such embodiments, an enclosed end of the telescoping protrusion 16 (e.g., the smallest/last torus geometry) may be utilized to directly apply vibration in use. Such configuration may allow for a fully sealed distal end of the telescoping protrusion 16.

Referring predominately to FIGS. 2-5, the operable junction 18 and/or proximal operable junction 18a generally acts as a junction coupling (e.g., operably, mechanically, electrically, or the like) two or more of the other individual components of the TPM 10 together. In some embodiments, the operable junction 18 and/or proximal operable junction 18a may include a bracket, base, or the like coupled with or formed with any of the rings 12, 12a, 12b, such as all of the rings. Such operable junction 18 and/or proximal operable junction 18a may structurally support any of such components together as well to the telescoping portion 16, and potentially operably coupling any of such components together. However, in alternative embodiments, the operable junction 18, the proximal operable junction 18a, and/or the distal operable junction 18b may be configured as one or more couplers between the ring(s) 12, vibration devices 14, and/or the telescoping protrusion 16 to communicate signals therebetween (e.g., vibrations, electrical signals, control signals, power, and the like) without providing an integral external structure or housing, as depicted. For instance, the operable junction(s) 18, proximal operable junction 18a, and/or distal operable junction 18b may be physically smaller than one or more of the vibration device(s) 14 and ring(s) 12 and simply arranged between such components. In such embodiments, an additional and optional housing may be provided to structurally support the components of the TPM 10 relative to one another.

Referring now also to FIG. 6, an exploded view of an electronics module of an operable junction suitable for use with a telescoping personal massager is illustrated in accordance with aspects of the present subject matter. As shown, an electronics module 18c and/or an operable junction 18 or proximal operable junction 18a configured as an electronics module 18c may generally include an interface 18e to receive user inputs. Optionally and as shown, the operable junction 18, proximal operable junction 18a, and/or electronics module 18c may include additional structural elements, housings, fixtures, or the like supporting components with respect to one another and protecting sensitive components from exposure. As shown, the operable junction 18, proximal operable junction 18a, and/or electronics module 18c may include a control unit 18d and/or the proximal vibration device 14a. It should be appreciated that, while control unit 18d and proximal vibration device 14a are illustrated as a single assembled unit in FIG. 6, alternative embodiments of the control unit 18d may be communicatively coupled with an external proximal vibration device 14a provided proximate to the ring(s) 12, 12a, 12b and/or the proximal end of the telescoping protrusion 16.

Furthermore, the electronics module 18c may include a charging system allowing for a battery thereof to be charged via a wired or wireless connection. Embodiment of a suitable battery may include a sealed, rechargeable battery and/or a battery with moisture ingress protection targets, such as IPX7 or better. In some embodiments, the proximal operable junction 18a and/or electronics module 18c may be removable (see, e.g., FIG. 3) allowing for access to an internal charging port. An interface between the proximal operable junction 18a and/or electronics module 18c and the telescoping protrusion 16 may be watertight, when assembled, in order to protect the water-sensitive electrical components from moisture ingress. In embodiments configured for wireless charging, such interface between the proximal operable junction 18a and/or electronics module 18c and the telescoping protrusion 16 may be permanent or semi-permanent, which may allow for a more robust seal between such components.

In the depicted embodiment of FIG. 6, the distal vibration device 14b may be communicatively coupled with the control unit 18d, such as via the electrical conduit(s) 25 enclosed within the telescoping protrusion 16 during use. The control unit 18d generally provides power and operation control to the vibration device(s) 14, 14a, and/or 14b operably coupled to the same. For instance, the control unit 18d may be configured to implement a BLE vibration mode/pattern, an RF vibration mode/pattern, or other suitable vibration modes and patterns.

Furthermore or alternatively, the control unit 18d may be configured to provide synchronous, asynchronous, and/or phase-offset control to different vibration devices 14, e.g., each of the proximal vibration device 14a and the distal vibration device 14b in at least one configuration. For example, synchronous control may include controlling the vibration device(s) 14, 14a, 14b such that vibration is provided at the same frequency and the same phase (e.g., a 0 degrees/0 pi phase shift or a multiple of 360 degrees/2 pi phase shifts), which may be synchronized in time such that the provided vibration is synchronized, substantially synchronized, simultaneous, substantially simultaneous, or the like between the vibration devices 14, 14a, 14b. However, it should be appreciated that such synchronized vibration may be provided at different magnitudes, which may be selectable via the interface 18e and implemented in response to signals communicated from the control unit 18d. Embodiments of phase-offset control, as used herein, may include controlling the vibration device(s) 14, 14a, 14b such that vibration is provided at the same frequency but with a phase shift (e.g., a phase shift between but not including 0 degrees/0 pi and 360 degrees/2 pi or a multiple thereof) and potentially at the same magnitude or different magnitudes. Alternatively, such a phase shift may result in producing vibrations of the same frequency using the different vibration device(s) 14, 14a, 14b which are not simultaneous, e.g., one vibration pattern lags behind the other. Embodiments of asynchronous control, as used herein, may include controlling the vibration device(s) 14, 14a, 14b such that vibration is provided at different frequencies and optionally with different magnitudes and/or a phase shift between such different frequencies.

In some embodiments, the electrical conduit(s) 25 may be routed through the telescoping protrusion 16 in order to provide control and/or power to the distal vibration device 14b. For example, such electrical conduit(s) 25 may be routed through a crescent-shaped enclosure. In at least one instance, such crescent-shaped enclosure may be shaped with an arcuate underside and arranged within the telescoping protrusion 16 such that the arcuate underside conforms to a penile curve (e.g., an average curve or a personalized curve based on the anatomy of user), which may improve surface contact between the telescoping protrusion 16 and the male anatomy, increase stability, and/or improve comfort during use of the TPM 10. Personalization of the crescent-shaped enclosure may be accomplished by manufacturing such enclosure based on specifications, measurements, etc. of the user. In other embodiments, the crescent-shaped enclosure may be capable of plastic deformation. Thus, the crescent-shaped enclosure may be conformed to the anatomy of the user via repeated use of the TPM 10. Alternatively, the crescent-shaped enclosure may be selectively removable from the telescoping protrusion 16 such that the user may immediately conform its shape to his/her/their anatomy (e.g., fully conformed, substantially conformed, or the like to the user's anatomy). In still other embodiments, multiple, differently conformed crescent-shaped enclosures may be provided with the TPM 10, which may be exchanged to better match the anatomy of the user. Generally and in various embodiments, the arcuate underside and/or the conformed arcuate underside may encourage the telescoping protrusion 16 to sit more securely against the penis (e.g., the ventral side of the penis in most use cases). The crescent-shaped enclosure may result in targeted energy at the point of need and elastomeric filtering that yields softer, more comfortable impulses.

Referring now to FIGS. 3 and 6, some embodiments of the TPM 10 may be configured to allow for decoupling of the operable junction 18, the proximal operable junction 18a, the electronics module 18c, and/or the control unit 18d from the TPM 10 and/or telescoping protrusion 16. For example, one or more quick-disconnect electrical interfaces may permit selective and operable coupling of the operable junction 18, the proximal operable junction 18a, the electronics module 18c, and/or the control unit 18d to the TPM 10, the telescoping protrusion 16, the proximal vibration device 14a, and/or the distal vibration device 14b.

Referring now to FIGS. 1F, 6, and 7, in embodiments with a distal vibration device 14b, the distal attachment 26 may include the distal vibration device 14b, e.g., integrated within the distal attachment 26 as an assembly or the like. In such embodiments, the distal end of telescoping protrusion 16, the distal operable junction 18b, and/or distal attachment 26 may include complementary electrical interfaces for electrical communication between the control unit 18c and the integrated distal vibration device 14b. For example, the interface between the telescoping protrusion 16 or the distal operable junction 18b and the distal attachment 26 may include sealed electrical interfaces such as spring-loaded pogo contacts or magnetic-assisted pogo contacts.

In alternative embodiments, only one of the proximal vibration device 14a or distal vibration device 14b may be provided. In various embodiments, the electronics module 18c may be selectively received within the remainder of the operable junction 18, the proximal operable junction 18a, and/or at a proximal end of the telescoping protrusion 16. Thus, once assembled, the operable junction 18, proximal operable junction 18a, electronics module 18c, and/or the control 18d may control operation of the vibration device(s) 14, 14a, 14b and optionally based on control signal received via the interface 18e.

The control unit, as described herein, may be a digital computer that, in terms of hardware architecture, may include one or more of a processor, input/output (I/O) interfaces, a network interface, a data store, and memory. It should be appreciated by those of ordinary skill in the art that a practical embodiment may include additional components and suitably configured processing logic to support known or conventional operating features that are not described in detail herein. The components may be communicatively coupled via a local interface. The local interface may be, for example, but is not limited to, one or more buses or other wired or wireless connections, as is known in the art. The local interface may have additional elements, which are omitted for simplicity, such as controllers, buffers (caches), drivers, repeaters, and receivers, among many others, to enable communications. Further, the local interface may include address, control, and/or data connections to enable appropriate communications among the aforementioned components.

The processor may be a hardware device for executing software instructions. The processor may be any custom made or commercially available processor, a central processing unit (CPU), an auxiliary processor among several processors associated with a server, a semiconductor-based microprocessor (in the form of a microchip or chipset), or generally any device for executing software instructions. When in operation, the processor may be configured to execute software stored within the memory, to communicate data to and from the memory, and to generally control operations of the control unit pursuant to the software instructions. The I/O interfaces may be used to receive user input from and/or for providing system output to one or more devices or components. For example, user input can be provided via a buttons, a touch screen, a scroll ball, a scroll bar, and the like. System output can be provided via a display device such as a liquid crystal display (LCD), a simple light indicator and/or different modulations of an LED indicator, a touch screen, and the like.

The data store may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store may incorporate electronic, magnetic, optical, and/or other types of storage media. In one example, the data store may be located internal to the control unit, such as, for example, an internal hard drive connected to the local interface.

The memory may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory may incorporate electronic, magnetic, optical, and/or other types of storage media. Note that the memory may have a distributed architecture, where various components are situated remotely from one another but can be accessed by the processor. The software in memory may include one or more software programs, each of which includes an ordered listing of executable instructions for implementing logical functions. The software in the memory may include a suitable operating system (O/S) and one or more programs. The O/S may essentially control the execution of other computer programs, such as the one or more programs, and provide scheduling, input-output control, file and data management, memory management, and communication control and related services. The one or more programs may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” “a control unit” “configured” or “adapted” “to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the scope of the present disclosure, are contemplated thereby, and are intended to be covered by the following, non-limiting Claims for all purposes.

What is claimed is:

1. A telescoping personal massager, comprising:
at least one retention member configured to be worn on a body part of a male user or attached to a garment of a first user;
at least one vibration device supported relative to the at least one retention member;
a telescoping protrusion supported relative to the at least one retention member and operably coupled with the at least one vibration device positioned at a proximal end of the telescoping protrusion, the telescoping protrusion configured to passively maintain contact between a distal end of the telescoping protrusion and an anatomy of a second user during use; and
at least one operable connection coupling the at least one retention member, the at least one vibration device, and the telescoping protrusion together, the at least one operable connection including a control unit configured to provide operational control of the at least one vibration device.

2. The telescoping personal massager of claim 1, wherein the at least one vibration device is coupled between the at least one retention member and the telescoping protrusion.

3. The telescoping personal massager of claim 1, wherein the telescoping protrusion comprises an internal waveguide configured to operably couple to the at least one vibration device and to communicate vibrations from the at least one vibration device to the distal end of the telescoping protrusion.

4. The telescoping personal massager of claim 1, wherein the at least one retention member includes an internal waveguide member configured to operably couple with the at least one vibration device and to communicate vibrations from the at least one vibration device throughout the at least one retention member.

5. The telescoping personal massager of claim 1, wherein the at least one vibration device is disposed at a periphery of the at least one retention member.

6. The telescoping personal massager of claim 1, wherein the telescoping protrusion is operably coupled directly to the at least one vibration device.

7. The telescoping personal massager of claim 1, further comprising:
an operable junction selectively coupled between the at least one vibration device and the telescoping protrusion, the operable junction operably coupled to the at least one vibration device and configured to selectively couple to the telescoping protrusion.

8. The telescoping personal massager of claim 1, further comprising:
an electronics module selectively receivable at the proximal end of the telescoping protrusion and configured to control operation of the at least one vibration device.

9. The telescoping personal massager of claim 1, wherein a length of the telescoping protrusion is biased to a fully extended length and compressible along the length in use.

10. The telescoping personal massager of claim 1, wherein the telescoping protrusion further includes at least one elastomeric bellow or elastomeric spring configured to bias a length of the telescoping protrusion to a fully extended length.

11. The telescoping personal massager of claim 1, wherein the distal end of the telescoping protrusion is configured to selectively retain a distal attachment.

12. The telescoping personal massager of claim 11, wherein the telescoping protrusion is configured to communicate vibration generated by the at least one vibration device such that simultaneous vibration is provided at each of the distal attachment and the at least one retention member during use of the telescoping personal massager.

13. The telescoping personal massager of claim 1, further comprising:
a hygienic cover enclosing at least one of the at least one retention member, the at least one vibration device, or the telescoping protrusion.

14. The telescoping personal massager of claim 13, wherein the hygienic cover includes at least one of a zoned durometer or a gradient durometer configured to alter a stiffness of the telescoping protrusion.

15. The telescoping personal massager of claim 1, wherein the at least one retention member includes a first ring structure and a second ring structure, each of the at least one vibration device and the telescoping protrusion coupled between the first ring structure and the second ring structure.

16. The telescoping personal massager of claim 1, wherein the at least one retention member includes a first ring structure defined along a first plane and a second ring structure defined along a second plane pivotably coupled to the first ring structure such that an angle between the first plane and the second plane is selectively adjustable.

17. The telescoping personal massager of claim 1, wherein the at least one retention member includes a first ring structure defined along a first plane and a second ring structure defined along a second plane, and wherein an angle defined between the first plane and the second plane is between 0 degrees and 45 degrees.

18. A telescoping personal massager, comprising:
at least one retention member configured to be worn on a body part of a male user or attached to a garment of a first user;
a telescoping protrusion supported relative to the at least one retention member at a proximal end of the telescoping protrusion;
a first vibration device coupled between the at least one retention member and the telescoping protrusion;
a distal attachment configured to selectively couple to a distal end of the telescoping protrusion, the distal attachment including a second vibration device;
a proximal operable connection coupling the first vibration device to the telescoping protrusion, the proximal operable connection including a control unit configured to control operation of the first vibration device and the second vibration device; and
at least one electrical conduit selectively couplable between the control unit and the second vibration device and receivable within the telescoping protrusion,
wherein the telescoping protrusion is configured to passively maintain contact between the distal attachment and an anatomy of a second user during use of the telescoping personal massager.

19. The telescoping personal massager of claim 18, further comprising:
a distal operable connection configured to allow the selective coupling of the distal attachment to the distal end of the telescoping protrusion, the distal operable connection including a quick-disconnect electrical interface.

20. A telescoping personal massager, comprising:
at least one retention member configured to be worn on a body part of a male user or attached to a garment of a first user;
a telescoping protrusion supported relative to the at least one retention member at a proximal end of the telescoping protrusion;
a distal attachment configured to selectively couple to a distal end of the telescoping protrusion, the distal attachment including a vibration device;
a proximal operable connection coupling the at least one retention member to the telescoping protrusion, the proximal operable connection including a control unit configured to control operation of the vibration device;
a distal operable connection configured to allow the selective coupling of the distal attachment to the distal end of the telescoping protrusion; and
at least one electrical conduit selectively couplable between the control unit and the vibration device and receivable within the telescoping protrusion,
wherein the telescoping protrusion is configured to communicate vibration generated by the vibration device such that simultaneous vibration is provided at each of the distal attachment and the at least one retention member during use of the telescoping personal massager.
